(19) United States
(12) Patent Application Publication
(10) Pub. No.: US 2014/0140636 A1
(43) Pub. Date: May 22, 2014

(54) Anisotropic Gradient Regularization for Image Denoising, Compression, and Interpolation

(71) Applicants: Wenfei Jiang, Beijing (CN); Jian Jin, Beijing (CN); Zhi Bo Chen, Beijing (CN)

(72) Inventors: Wenfei Jiang, Beijing (CN); Jian Jin, Beijing (CN); Zhi Bo Chen, Beijing (CN)

(73) Assignee: THOMSON LICENSING, Issy de Moulineaux (FR)

(21) Appl. No.: 14/131,534

(22) PCT Filed: Aug. 30, 2011
(86) PCT No.: PCT/CN2011/079093

§ 371 Date: Jan. 9, 2014

(51) Int. Cl. G06T 5/00

(52) U.S. Cl. CPC G06T 5/002
USPC 382/266

(57) ABSTRACT

De-noising an image by Anisotropic Gradient Regulation commences by first choosing edge directions for the image. Thereafter, an anisotropic gradient norm is established for the image from anisotropic gradient norms along the selected edge directions. The image pixels undergo adjustment to minimize the anisotropic gradient norm for the image, thereby removing image noise.

### TECHNICAL FIELD

This invention relates to a technique for restoring a video image, and more particularly, for denoising the image.

### BACKGROUND ART

Image restoration generally constitutes the process of estimating an original image (which is unknown) from a noisy or otherwise flawed image. Ideally, the estimated image should be substantially free of noise so that image restoration constitutes a form of de-noising. During the image restoration, various tools can prove useful, such as gradient image analysis. Although the differences between adjacent pixels in natural images often appears small, the /1 and /2 norm of color values in the image gradients usually increase when a natural image becomes distorted so gradient image analysis can provide a measure of image distortion.

Image gradients also play a part in image restoration, and particularly, image de-noising. Total Variation (TV), which makes use of image gradient, serves as a popular tool for image denoising because of its capability of performing denoising while preserving the image edges. In addition, TV denoising generates high resolution images from lower resolution versions very well while serving to recover images with highly incomplete information.

Typically, calculation of the Total variation depends on the horizontal and vertical gradient images. An image can be defined by its horizontal and vertical gradient images, ∇ₓI and ∇_{y}I, respectively, as follows

∇ₓI(x,y)=I(x+1,y)−I(x,y)

∇_{y}I(x,y)=I(x,y+1)−I(x,y)^{.} (1)

Then Total Variation (TV) is calculated by

TV(I)=Σ_{i,j}\sqrt{∇ₓI(i,j)²+∇_{y}I(i,j)²} (2)

or TVII)=Σ_{i,j}|∇ₓI(i,j)|+|∇_{y}IIi,j)|. (3)

Classical TV denoising seeks to minimize the Rudin-Osher-Fatemi (ROF) denoising

$$model {min}_{f} T V ( f ) + \frac{λ}{2} {‖ f - n ‖}_{2}^{2} \qquad ( 4 )$$

where n is the noisy image, TV(ƒ) represents the total variation of ƒ, and λ is a parameter which controls the denoising intensity.

Traditional TV regularization, as provided in Equation. (2) does not consider the content of images. Rather, tradition TV denoising serves to smooth the image with equivalent intensity from both horizontal and vertical directions. Therefore, the edges undergo smoothing more or less after TV denoising, especially the oblique edges.

An improved version of TV, referred to as called Directional Total Variation, makes use of the /2 norm of a pair of gradient images along the edge direction and its orthogonal direction. Directional TV regularization outperforms traditional TV regularization in both subjective and objective quality, and does particularly well in preserving oblique texture and edges. In contrast, the existing TV regularization technique actually presumes the smoothness along all directions. In other words, the existing TV regularization technique tries to smooth the image along all directions by minimizing the norm of gradients along two orthogonal directions. As a result, the existing TV regularization technique inevitably blurs or even removes the edges and textures. Although a proposal exists to focus on smoothing along the edge by applying different larger weights, minimizing the norm of gradients along the other direction incurs difficulties.

Thus a need exists for a denoising technique that overcomes the aforementioned disadvantages.

### BRIEF SUMMARY OF THE INVENTION

Briefly, in accordance with a preferred embodiment of the present principles, a method for de-noising an image using Anisotropic Gradient Regulation commences by first choosing edge directions for the image. Thereafter, an anisotropic gradient norm is established for the image from anisotropic gradient norms along the selected edge directions. The image pixels undergo adjustment to minimize the anisotropic gradient norm for the image, thereby removing image noise.

### BRIEF DESCRIPTION OF THE DRAWINGS

FIG. 1 depicts a block schematic diagram of a system in accordance with the present principles for accomplishing image denoising using Anisotropic Gradient Regulation; and

FIG. 2 depicts a vector diagram showing candidate directions for anisotropic image gradients.

### DETAILED DISCUSSION

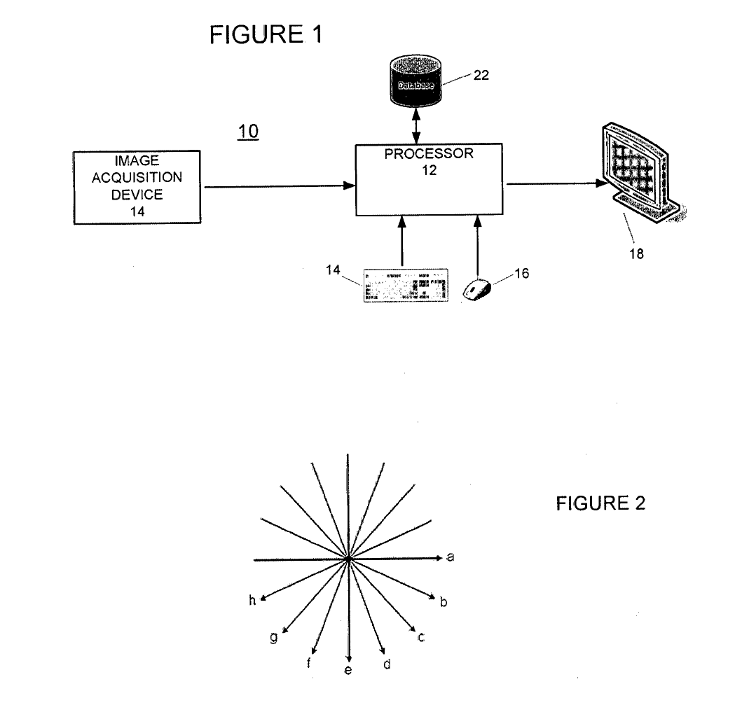

FIG. 1 depicts a system 10, in accordance with the present principles for accomplishing image denoising using Anisotropic Gradient Regulation in the manner discussed in greater detail hereinafter. The system 10 includes a processor 12, in the form of a computer, which executes software that performs image denoising Anisotropic Gradient Regulation. The processor 12 enjoys a connection to one or more conventional data input devices for receiving operator input. In practice, such data input devices include a keyboard 14 and a computer mouse 16. Output information generated by the processor undergoes display on a monitor 18. Additionally such output information can well as undergo transmission to one or more destinations via a network link 20.

The processor 12 enjoys a connection to a database 22 which can reside on a hard drive or other non-volatile storage device internal to, or separate from the processor. The database 22 can store raw image information as well as processed image information, in addition to storing software and/or data for processor use.

The system 10 further includes an image acquisition device 24 for supplying the processor 12 with data associated with one or more incoming images. The image acquisition device 24 can take many different forms, depending on the incoming images. For instance, if the incoming images are “live”, the image acquisition device 24 could comprise a television camera. In the event the images were previously recorded, the image acquisition device 24 could comprise a storage device for storing such images. Under circumstances where the images might originate from an another location, the image acquisition device 24 could comprise a network adapter for coupling the processor 12 to a network (not shown) for receiving such images. Although FIG. 2 depicts the image acquisition device 24 as separate from the processor, depending on how the images originate, the functionality of the image acquisition device 24 could reside in the processor 12.

Execution of the Anisotropic Gradient Regulation denoising technique of the present principles commences by first defining candidate directions for generate image gradients. As depicted in FIG. 2, eight candidate directions (a-h) are initially selected to generate image gradients. The directional gradients are defined as follows:

$$\{ \begin{matrix}{∇}_{a} I ( x , y ) = I ( x , y ) - I ( x - 1 , y ) \\ {∇}_{b} I ( x , y ) = I ( x , y ) - I ( x - 2 , y - 1 ) \\ {∇}_{c} I ( x , y ) = I ( x , y ) - I ( x - 1 , y - 1 ) \\ {∇}_{d} I ( x , y ) = I ( x , y ) - I ( x - 1 , y - 2 ) \\ {∇}_{e} I ( x , y ) = I ( x , y ) - I ( x , y - 1 ) \\ {∇}_{f} I ( x , y ) = I ( x , y ) - I ( x + 1 , y - 2 ) \\ {∇}_{g} I ( x , y ) = I ( x , y ) - I ( x + 1 , y - 1 ) \\ {∇}_{h} I ( x , y ) = I ( x , y ) - I ( x + 2 , y - 1 )\end{matrix} \qquad ( 5 )$$

Next, calculation the /2 norm of gradient along each direction occurs in accordance with the relationship Eₖ=Σ_{i,j}|∇ₖI(i,j)|², where (k ε {a, b, c, d, e, f, g, h}). Eₖ can serve as the mechanism for the direction determination.

The chosen edge directions are {k|Eₖ<th1}, where th is a predefined threshold.

Direction determination occurs in accordance with the following steps:
a) Pre-process the image in units of n×n blocks and obtain all candidate directional gradients, where n is the block size.
b) Calculate Eₖ for each directional gradient and select the direction most likely to lies along the image edges according to {k|Eₖ<th1}.
c) If there are more than th2 directions chosen in step b), keep the th2 directions with largest Eₖ while discard the rest. Typically th2=3.

Next, calculation of the /2 norm of the gradients occurs along the detected directions for each image region. The Anisotropic Gradient Norm (AGN) of a image region ƒₗ defined as follows:

AGN(ƒₗ)=Σ_{i,j}\sqrt{α∇ₚƒₗ(i,j)²+β∇_{q}ƒₗ(i,j)²+γ∇ᵣƒₗ(i,j)²} (6)

where p, q and r are the detected edge directions; α, β and γ are the weights for the gradients. Generally, smoothing of the image region (e.g., adjusting the pixels within the image region) along the smaller-norm-directions with higher intensity remains preferable.

$$α = {e}^{- \frac{{E}_{p}}{{E}_{P} + {E}_{q} + {E}_{r}}} \\ β = {e}^{- \frac{{E}_{q}}{{E}_{P} + {E}_{q} + {E}_{r}}} \\ γ = {e}^{- \frac{{E}_{r}}{{E}_{P} + {E}_{q} + {E}_{r}}} \qquad ( 7 )$$

However, it is unnecessary to use three directions for all image regiones. If there are only 2 edge directions detected in a image region, the other weight can be set to 0. For the entire image, the Anisotropic Gradient Norm is calculated from the sum of AGNs of all the image regiones as follows:

AGN(ƒ)=ΣₗAGN(ƒₗ) (8)

Note that some gradients of the boundary pixels of a image region require the pixels within other image regiones, so the calculation of AGN of an image may occur across image regiones.

The Anisotropic Gradient Regularization technique discussed above tends to enhance the edges and texture. The technique makes real edges sharper but can also generate false edges. This problem can be addressed by making use of intensity adaptation in the regularization loop. Anisotropic Gradient Regularization for image denoising can be formulated as:

$${min}_{f} A G N ( f ) + \frac{λ}{2} {‖ f - n ‖}_{2}^{2} \qquad ( 9 )$$

where λ is the intensity parameter.
   Basically, for the smooth regions of an image, a smaller λ can be used, and vice versa. In the literatures, λ is always chosen as a constant or estimated iteratively from the variance between the noisy image n and its iterative image ƒₙ. For example, at the nth iteration, a proper λ can be chosen as

$${λ}_{n} = \frac{TV ( {u}_{n} )}{{‖ {f}_{n} - n ‖}_{2}^{2}} \qquad ( 10 )$$

Other methods use a constant multiplier to update λ. For example, consider the relationship:

λₙ=ηλₙ₋(0<η<1) (11)

where λ turns smaller after each iteration since the noise becomes less.

However, better results occur by calculating λ according to the content of each region of images.

Implementation of Regularization Intensity Adaptation occurs in the following manner. Given λ₀ as an initial value, λₙ is updated after each iteration. At the nth iteration, the ratio of the maximum norm of the gradients to the minimum is calculated.

$$ρ {=}^{Δ} \frac{min \{ {E}_{k} , i = 1 , 2 , … , 8 \}}{max \{ {E}_{k} , i = 1 , 2 , … , 8 \}} \qquad ( 12 )$$

Given a threshold th, ρ can approximately indicate whether the region is smooth or complicated.

if ρ>th, the region is relatively smooth. Then λₙ=η₁λₙ₋₁;

If ρ≦th, the region is relatively complicated. λₙ=η₂λₙ₋.

where 1>η₂>η₁>0. We set η₁=0.85, η₂=0.95 in practice.

Advantageously, Anisotropic Gradient Regularization with adaptive intensity does not generate obvious false textures.

For the texture/edge directions of the image regiones within a noisy image, Anisotropic Gradient Regularization denoising occurs performed by minimizing the Anisotropic Gradient Norm (AGN) of the image as follows.

$${min}_{f} A G N ( f ) + \frac{λ}{2} {‖ f - n ‖}_{2}^{2} , \qquad ( 13 )$$

where n is the input noisy image. The edge directions are determined as discussed above. Anisotropic Gradient Regularization denoising significantly outperforms the traditional TV denoising.

Keeping the image edges sharp at the high resolution remains a critical problem in interpolation/super resolution Intuitive bi-linear/bi-cubic interpolation usually introduces blur during interpolation. Total Variation (TV) regularization-based interpolation provides a better solution since TV regularization utilizes the intensity continuity of natural images as prior information during the up-sampling process using the following relationship.

$${min}_{f} T V ( f ) + \frac{λ}{2} {‖ y - Φ f ‖}_{2}^{2} \qquad ( 14 )$$

where Φ is a down-sampling matrix, γ is the low resolution image and ƒ is the up-sampled version.

Since Total Variation (TV) regularization does not detect and protect the texture and edges in the image, TV regularization cannot generate high resolution images with sharp (oblique) edges. However, as discussed above, the de-noising technique of the present principles depends on the minimization of the AGN in accordance with the following relationship:

$${min}_{f} A G N ( f ) + \frac{λ}{2} {‖ y - Φ f ‖}_{2}^{2} \qquad ( 15 )$$

The restoration technique of the present principles detects all the probable edges and generates anisotropic gradients; then the interpolation occurs by minimizing the norm the anisotropic gradients and the difference between the down-sampled version and the input image. In this way, the up-sampled images contain shaper edges and less blur.

The foregoing describes a technique for de-noising an image.

1. A method for de-noising an image, comprising the steps of:
choosing edge directions for the image;
establishing an anisotropic gradient norm for the image from anisotropic gradient norms along the selected edge directions; and
adjusting image pixels to minimize the anisotropic gradient norm for the image and thereby remove image noise.

2. The method according to claim 1 wherein the step of choosing the edge directions comprising the steps of:
dividing the image into regions;
establishing a gradient norm along each of a plurality of initially directions for each image region;
selecting edge direction most likely to lie along image edges in accordance with the gradient norm.

3. The method according to claim 2 wherein the step of establishing an anisotropic gradient norm comprises the steps of:
establishing an anisotropic gradient norm for each image region along the selected directions; and
summing the anisotropic gradient norm for the image regions to yield the anisotropic gradient norm for the image.

4. The method according to claim 3 wherein the step of establishing an anisotropic gradient norm for each image region further includes the step of smoothing said each region along directions with a smaller gradient norm and high intensity.

5. The method according to claim 1 wherein the the image pixels are adjusted to minimize the anisotropic gradient norm in accordance with the relationship
$${min}_{f} A G N ( f ) + \frac{λ}{2} {‖ f - n ‖}_{2}^{2}$$
where ƒ presepends an image region, n represents image noise and λ is an image intensity parameter which undergoes interactive updating depending on smoothness of a given image region.

6. The method according to claim 1 wherein the the image pixels are adjusted to minimize the anisotropic gradient norm in accordance with the relationship
$${min}_{f} T V ( f ) + \frac{λ}{2} {‖ y - Φ f ‖}_{2}^{2}$$
where ƒ is an up-sampled matrix of the image and Φ is a down-sampled matrix of the image.

7. Apparatus for de-noising an image, comprising the steps of:
means for choosing edge directions for the image;
means for establishing an anisotropic gradient norm for the image from anisotropic gradient norms along the selected edge directions; and
means for adjusting image pixels to minimize the anisotropic gradient norm for the image and thereby remove image noise.

8. The apparatus according to claim 7 wherein the means for choosing the edge directions comprises:
means for dividing the image into regions;
means for establishing a gradient norm along each of a plurality of initially directions for each image region;
means for selecting edge direction most likely to lie along image edges in accordance with the gradient norm.

9. The apparatus according to claim 8 wherein the means for establishing an anisotropic gradient norm comprises:
means for establishing an anisotropic gradient norm for each image region along the selected directions; and
means for summing the anisotropic gradient norm for the image regions to yield the anisotropic gradient norm for the image.

10. The apparatus according to claim 9 wherein the means for establishing an anisotropic gradient norm for each image region further includes means for smoothing said each region along directions with a smaller gradient norm and high intensity.

11. The apparatus according to claim 7 the image pixel adjusting means minimizes the anisotropic gradient norm in accordance with the relationship
$${min}_{f} A G N ( f ) + \frac{λ}{2} {‖ f - n ‖}_{2}^{2}$$
whereƒ represents an image region, n represents image noise and λ is an image intensity parameter which undergoes iterative updating depending on smoothness of a given image region.

12. The apparatus according to claim 7 the image pixel adjusting means minimizes the anisotropic gradient norm in accordance with the relationship
$${min}_{f} T V ( f ) + \frac{λ}{2} {‖ y - Φ f ‖}_{2}^{2}$$
where ƒ is an up-sampled matrix of the image and Φ is a down-sampled matrix of the image.
